(19) United States
(12) Patent Application Publication
(10) Pub. No.: US 2022/0312947 A1
(43) Pub. Date: Oct. 6, 2022

(54) SHOWER HOSE CLEANER

(71) Applicant: Myung Hun JUNG, Gwangju-si (KR)

(72) Inventor: Myung Hun JUNG, Gwangju-si (KR)

(21) Appl. No.: 17/703,692

(22) Filed: Mar. 24, 2022

(30) Foreign Application Priority Data
Apr. 1, 2021 (KR) 10-2021-0042470

(51) Int. Cl. A46B 11/06; A47K 3/28; B08B 9/023; A46B 9/02; A46B 5/00

(52) U.S. Cl. CPC A46B 11/063; A47K 3/281; B08B 9/023; A46B 9/026; A46B 5/0058; B08B 2209/02; A46B 2200/3013

(57) ABSTRACT

The present invention relates to a shower hose cleaner having a new structure that can easily clean a shower hose connected to a shower head. The shower hose cleaner according to the present invention is configured to comprise a case 10 having a tubular shape extending in a longitudinal direction and a brush member 20 provided on an inner circumferential surface of the case 10, and the case 10 is configured to be able to be divided into two parts. When the case 10 is coupled to an outside of the shower hose 2 and slid in the longitudinal direction of the shower hose 2, an outer circumferential surface of the shower hose 2 is cleaned by the brush member 20, and the shower hose 2 can be easily cleaned.

### FIELD OF THE INVENTION

The present invention relates to a shower hose cleaner having a new structure that can easily clean a shower hose connected to a shower head.

### BACKGROUND OF THE INVENTION

In general, a handheld shower used when taking a shower consists of a shower head 1 and a shower hose 2 connected to the shower head 1 as shown in FIG. 1, and an end of the shower hose 2 is connected to a faucet 3.

Accordingly, when a valve of the faucet 3 is open, water discharged from the faucet 3 is supplied to the shower head 1 through the shower hose 2 so that a user can take a shower.

Meanwhile, the shower hose 2 is configured by combining an external hose manufactured by winding a metal strip in a coil form with an outside of a hose body made of synthetic resin.

When this handheld shower is used for a long time, contaminants are attached to the outer surface of the shower hose 2, and thus, the shower hose 2 becomes dirty.

However, there is a very cumbersome problem to clean the shower hose 2 due to its structure.

Therefore, there is a need for a new method to easily clean the shower hose 2.

### PRIOR ART

(Patent Document 0001) Korean Patent Publication No. 10-2001-0085125.

### DETAILED DESCRITION OF THE INVENTION

### Technical Problems

The present invention is to solve the above problems, and the object of the present invention is to provide a shower hose cleaner having a new structure so that a shower hose 2 connected to a shower head 1 can be easily cleaned.

### SUMMARY OF THE INVENTION

To achieve the object described above, the present invention provides a shower hose cleaner for cleaning a shower hose 2 connected to a shower head 1. The shower hose cleaner comprising: a case 10 having a tubular shape extending in a longitudinal direction, and a brush member 20 provided on an inner circumferential surface of the case 10, wherein the case 10 is configured to be divided into two parts, wherein when the case 10 is coupled to an outside of the shower hose 2 and slid in the longitudinal direction of the shower hose 2, an outer circumferential surface of the shower hose 2 is cleaned by the brush member 20.

According to another feature of the present invention, a front end and a rear end of an inner circumferential surface of the case 10 are formed with the locking projections 14 protruding inward, and the brush member 20 is fixed to the inner circumferential surface of the case 10 in such a way that a front end and a rear end of the brush member 20 are caught on the locking projections 14.

According to another feature of the present invention, the brush member 20 includes a sheet member 21 that is adhesively fixed to the inner circumferential surface of the case 10 and a plurality of wire members 22 fixed to extend inward from the sheet member 21, and the wire member 22 is bent in such a way that its inner end is rounded.

According to another feature of the present invention, the shower hose 2 is connected to a faucet 3, and the case includes: a space portion 15 formed therein and a plurality of spraying holes 16 formed in an inner circumferential surface of the case 10 and connected to the space portion 15. The shower hose cleaner further comprises: a water collection bag 31 that is coupled to the shower head 1 to surround an outside of the shower head 1 and collects water discharged from the shower head 1, and a water supply pipe 32 connecting between the water collection bag 31 and the space portion 15, wherein when the case 10 and the brush member 20 are coupled to the outside of the shower hose 2, the water collection bag 31 is coupled to the outside of the shower head 1, and the faucet 3 is open to discharge water from the shower head 1, water discharged from the shower head 1 is collected in the water collecting bag 31 and is supplied to the space portion 15 of the case 10 through the water supply pipe 32, and water supplied to the space portion 15 is sprayed onto the outer circumferential surface of the shower hose 2 through the spraying hole 16.

### TECHNICAL EFFECTS OF THE INVENTION

The shower hose cleaner according to the present invention is configured to comprise a case 10 having a tubular shape extending in a longitudinal direction and a brush member 20 provided on an inner circumferential surface of the case 10, and the case 10 is configured to be able to be divided into two parts. When the case 10 is coupled to an outside of the shower hose 2 and slid in the longitudinal direction of the shower hose 2, an outer circumferential surface of the shower hose 2 is cleaned by the brush member 20, and the shower hose 2 can be easily cleaned.

### BRIEF DESCRIPTION OF THE DRAWINGS

FIG. 1 is a drawing illustrating a general handheld shower.

FIG. 2 is a side view illustrating a shower hose cleaner according to the present invention.

FIG. 3 is a side cross-section view illustrating a shower hose cleaner according to the present invention.

FIG. 4 is a front side cross-section view illustrating a shower hose cleaner according to the present invention.

FIG. 5 is a front side cross-section view illustrating a state in which a case of the shower hose cleaner is open according to the present invention.

FIG. 6 is a side cross-section view illustrating a method of using a shower hose cleaner according to the present invention.

FIG. 7 is a drawing illustrating another embodiment of a shower hose cleaner according to the present invention.

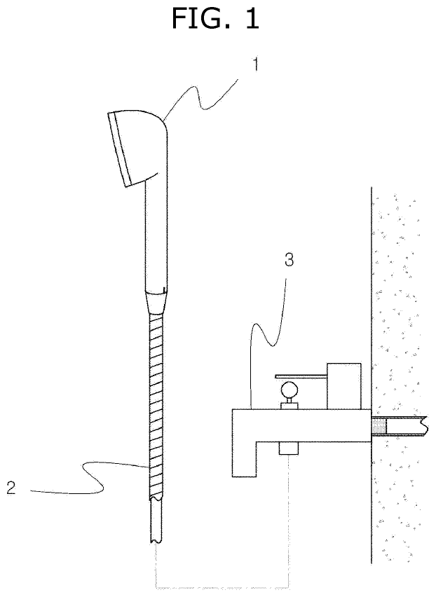

### DETAILED DESCRIPTION

Hereinafter, the present invention will be described in detail based on the accompanying illustrative drawings.

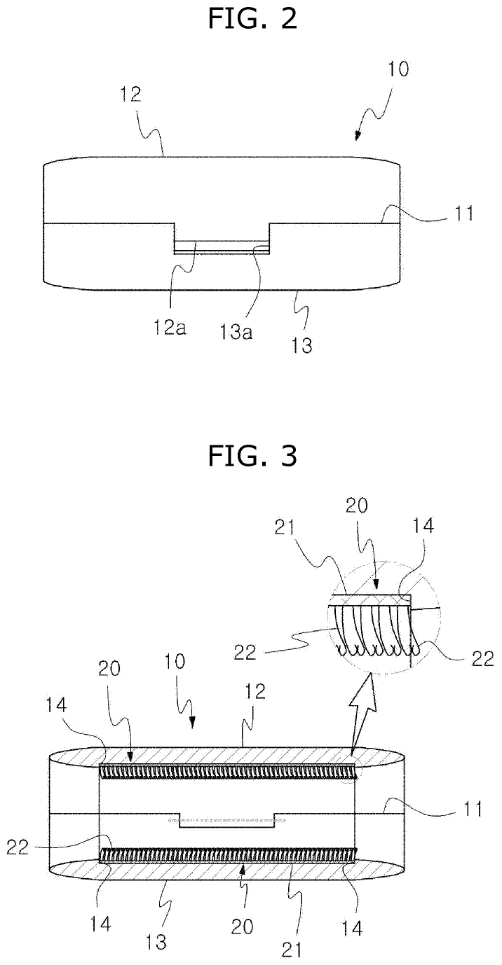

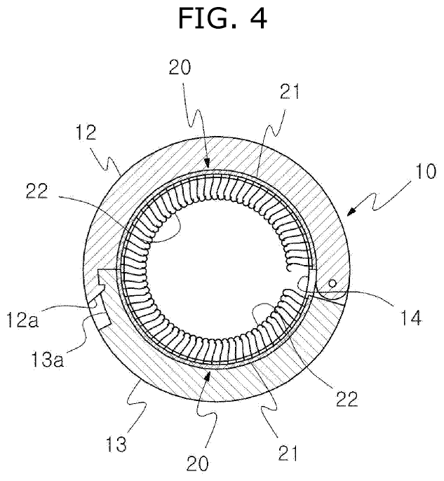

FIGS. 2 to 6 illustrate a shower hose cleaner according to the present invention. The shower hose 2 has ends each of which is connected to the shower head 1 and a faucet 3, respectively. The shower hose 2 is configured to supply water discharged from the faucet 3 to the shower head 1.

The shower hose cleaner according to the present invention is configured to comprise a case 10 having a tubular shape extending in a longitudinal direction and a brush member 20 provided on an inner circumferential surface of the case 10.

The case 10 is configured in a form of a cylindrical tube made of synthetic resin material and is configured to be divided into two parts based on a parting line 11 extending in the longitudinal direction.

That is, the case 10 is configured by mutually coupling an upper case 12 and a lower case 13 each of which has a semicylindrical shape. In this case, one sides of the upper and lower case 12, 13 are hinged together so that the upper and lower case 12, 13 are rotatable with respect to each other. The other side of the upper case 12 is provided with a coupling piece 12a coupled to a coupling groove 13a formed in the lower case 10. Accordingly, the case 10 can be open by rotating the upper case 12 upward. On the other hand, by rotating the upper case 12 downward so that the coupling piece 12a is coupled to the coupling groove 13a, the case 10 can be coupled in a cylindrical shape.

In this case, locking projections 14 protruding inward are formed at a front end and a rear end of the inner circumferential surface of the case 10, respectively.

The brush member 20 includes a sheet member 21 that is adhesively fixed to the inner circumferential surface of the case 10 and a plurality of wire members 22 fixed to extend inward from the sheet member 21.

In this case, the wire member 22 is bent in such a way that its inner end is rounded.

This brush member 20 may be the same as a generally used Velcro member. Since the Velcro member is manufactured in various sizes and generally used, a detailed description thereof will be omitted.

The sheet member 21 is configured of two sheets, and each sheet is attached and fixed to the inner circumferential surface of the upper and lower case 10 in such a way that a front end and a rear end of each sheet is in close contact with the locking protrusions 14.

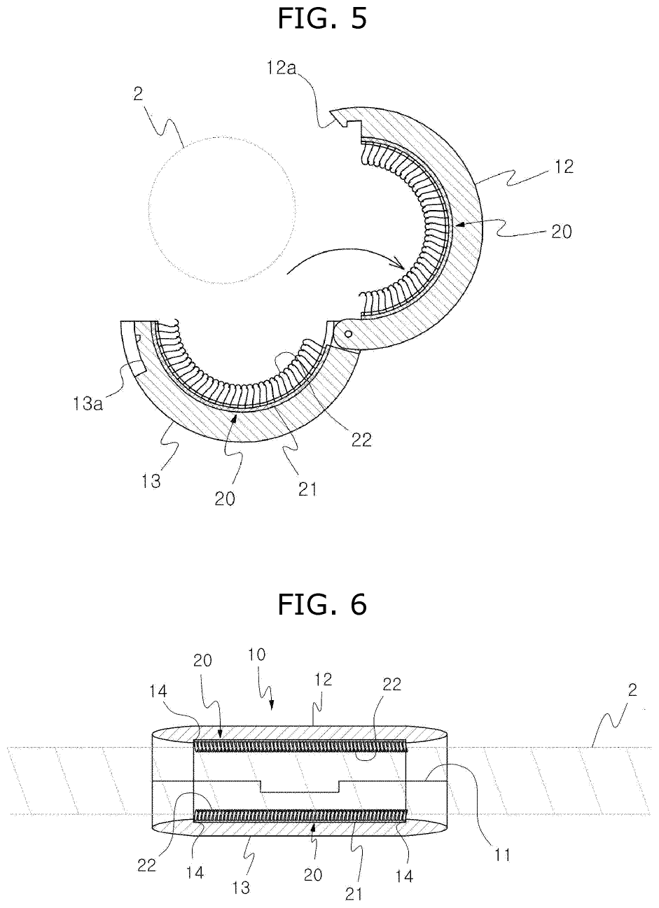

Therefore, as shown in FIG. 5, when the case 10 is open, the upper and lower case 12, 13 are positioned on the outer surface of the shower hose 2, and the upper and lower case 12, 13 are coupled to each other, surrounding the shower hose 2, the wire member 22 of the brush member 20 is in close contact with the outer circumferential surface of the shower hose 2, as shown in FIG. 6.

Then, when a user slides the shower hose cleaner in the longitudinal direction of the shower hose 2, the wire member 22 scrubs and wipes contaminants on the outer circumferential surface of the shower hose 2, and the outer circumferential surface of the shower hose 2 can be cleaned.

That is, the shower hose cleaner configured as described above is configured to comprise the case 10 having a tubular shape extending in the longitudinal direction and the brush member 20 provided on the inner circumferential surface of the case 10, and the case 10 is configured to be able to be divided into two parts. When the case 10 is coupled to the outside of the shower hose 2 and then slid in the longitudinal direction of the shower hose 2, the outer circumferential surface of the shower hose 2 is cleaned by the brush member 20, and the shower hose 2 can be easily cleaned.

In addition, the front and rear end of the inner circumferential surface of the case 10 is formed with the locking projections 14 protruding inward, and since the brush member 20 is fixed to the inner circumferential surface of the case 10 in such a way that the front and rear end of the brush member 20 are caught on the locking projections 14, the brush member 20 is firmly fixed and does not move in the longitudinal direction during use, thereby improving durability of the shower hose cleaner.

Furthermore, since the brush member 20 may use Velcro material including the sheet member 21 that is adhesively fixed to the inner circumferential surface of the case 10 and a plurality of wire members 22 fixed to extend inward from the sheet member 21, manufacturing cost of the shower hose cleaner can be reduced.

In particular, since the wire member 22 is bent in such a way that its inner end is rounded, and the rounded portion of the wire member 22 forms a close, large contact area with the outer circumferential surface of the shower hose 2, contaminants attached to the shower hose 2 can be easily wiped off.

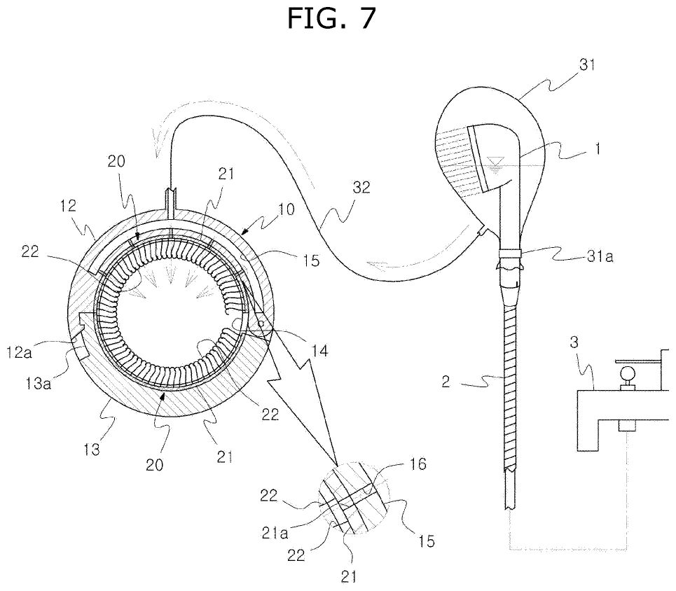

FIG. 7 illustrates another embodiment according to the present invention. A case 10, in particular an upper case 12, of a shower hose cleaner according to the embodiment of FIG. 7 includes a space portion 15 formed therein and a plurality of spraying holes 16 connected to the space portion 15.

In this case, the communicating hole 21a corresponding to the spraying hole 16 is formed in the sheet member 21 of the brush member 20.

In addition, the shower hose cleaner further comprises a water collection bag 31 that is coupled to surround an outside of the shower head 1 and collects water discharged from the shower head 1 and a water supply pipe 32 connecting between the water collection bag 31 and the space part 15.

The collection bag 31 is configured in a shape of an envelope made of elastic rubber or silicon material and provided with a tightening band 31a made of an elastic material at an entrance portion positioned at the bottom thereof.

Therefore, when the water collecting bag 31 is put on the outside of the shower head 1, the entrance portion of the water collecting bag 31 is tightened to an outer circumference of the shower head 1 in a watertight manner by the tightening band 31a.

The water supply pipe 32 is made of a flexible synthetic resin material.

The shower hose cleaner configured as described above can be used according to following steps. When the water collection bag 31 surrounds and is coupled to the shower head 1, and the faucet 3 is open to discharge water from the shower head 1, the water discharged from the shower head 1 is collected in the water collecting bag 31 and is supplied to the space portion 15 of the case 10 through the water supply pipe 32. The water supplied to the space portion 15 is sprayed onto the outer circumferential surface of the shower hose 2 through the spraying hole 16.

Therefore, when cleaning the shower hose 2, water is sprayed onto the outer circumferential surface of the shower hose 2, and the shower hose 2 can be cleaned more effectively.

What is claimed is:

1. A shower hose cleaner for cleaning a shower hose 2 connected to a shower head 1, the shower hose cleaner comprising:
a case 10 having a tubular shape extending in a longitudinal direction, and
a brush member 20 provided on an inner circumferential surface of the case 10,
wherein the case 10 is configured to be divided into two parts,
wherein when the case 10 is coupled to an outside of the shower hose 2 and slid in the longitudinal direction of the shower hose 2, an outer circumferential surface of the shower hose 2 is cleaned by the brush member 20,
wherein the shower hose 2 is connected to a faucet 3,
wherein the case includes:
a space portion 15 formed therein, and
a plurality of spraying holes 16 formed in an inner circumferential surface of the case and connected to the space portion 15,
wherein the shower hose cleaner further comprises:
a water collection bag 31 that is coupled to the shower head 1 to surround an outside of the shower head 1 and collects water discharged from the shower head 1, and
a water supply pipe 32 connecting between the water collection bag 31 and the space portion 15,
wherein when the case 10 and the brush member 20 are coupled to the outside of the shower hose 2, the water collection bag 31 is coupled to the outside of the shower head 1, and the faucet 3 is open to discharge water from the shower head 1, water discharged from the shower head 1 is collected in the water collecting bag 31 and is supplied to the space portion 15 of the case 10 through the water supply pipe 32, and water supplied to the space portion 15 is sprayed onto the outer circumferential surface of the shower hose 2 through the spraying hole 16.
